(19) United States
(12) Patent Application Publication
(10) Pub. No.: US 2008/0101070 A1
(43) Pub. Date: May 1, 2008

(54) Flexible light bar and its fabrication

(75) Inventor: Chin-Sung Chou, Chung-Ho City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Bright View Electronics Co., Ltd.

(21) Appl. No.: 11/808,401

(22) Filed: Jun. 8, 2007

(30) Foreign Application Priority Data
Jun. 13, 2006 (TW) 095120935

(51) Int. Cl. F21V 21/00

(52) U.S. Cl. 362/249

(57) ABSTRACT

A flexible light bar includes a flexible PC board having three electrical conducting paths in which the second electrical conducting path has two opposite ends respectively coupled to the first electrical conducting path and the third electrical conducting path and the first electrical conducting path and the third electrical conducting path each have a bonding metal contact at each of the two opposite ends thereof on the top and bottom sides of the flexible printed circuit board, and light emitting devices installed in the second electrical conducting path with the respective positive pole and negative pole respectively coupled to the first electrical conducting path and the third electrical conducting path. The light emitting devices are turned on to emit light upon connection of a DC power source to the bonding metal contacts of the first electrical conducting path and the third electrical conducting path.

### BACKGROUND OF THE INVENTION

1. Field of the Invention

The present invention relates to light emitting devices and more particularly, to a flexible light bar. The invention relates also to the fabrication of flexible light bar.

2. Description of the Related Art

FIG. 1 is a conventional light bar. According to this design, the light bar comprises a narrow, elongated flexible circuit board 200, a male connector 210 at one end of the circuit board 200, and a female connector 220 at the other end of the circuit board 200. By means of the male connector 210 of one light bar to the female connector 220 of another light bar, a plurality of light bars are connected in series. This design of light bar has the drawbacks of (1) because the male connector 210 and the female connector 220 have a certain thickness (height), the thickness (height) of the light bar is great, and (2) The use of the male connector 210 and the female connector 220 greatly increases the cost of the light bar.

### SUMMARY OF THE INVENTION

The present invention has been accomplished under the circumstances in view. It is therefore the main object of the present invention to provide a flexible light bar, which has a low profile.

It is another object of the present invention to provide a light bar, which is inexpensive to manufacture.

To achieve these and other objects of the present invention, the flexible light bar comprises a flexible printed circuit board, and a plurality of light emitting devices. The flexible printed circuit board comprises a first electrical conducting path, a second electrical conducting path, and a third electrical conducting path. The second electrical conducting path has two opposite ends respectively coupled to the first electrical conducting path and the third electrical conducting path. The first electrical conducting path and the third electrical conducting path each have two opposite ends and a bonding metal contact at each of the two opposite ends on top and bottom sides of the flexible printed circuit board. The light emitting devices are installed in the second electrical conducting path, each having a positive pole coupled to the first electrical conducting path and a negative pole coupled to the third electrical conducting path. The light emitting devices are turned on to emit light upon connection of a DC power source to the bonding metal contacts of the first electrical conducting path and the third electrical conducting path.

To achieve the aforesaid and other objects of the present invention, the flexible light bar fabrication method comprises the steps of: 1) providing a flexible printed circuit board having a first electrical conducting path, a second electrical conducting path, and a third electrical conducting path; 2) installing a bonding metal contact on each of top and bottom sides of the flexible printed circuit board at each of two opposite ends of each of the first electrical conducting path and the second electrical conducting path; and 3) installing a plurality of light emitting devices in the second electrical conducting path and electrically coupling positive pole and negative pole of each of the light emitting devices to the first electrical conducting path and the third electrical conducting path respectively.

In an alternate form of the present invention, the flexible light bar comprises a flexible printed circuit board, a plurality of first light emitting devices, a plurality of second light emitting devices, and a plurality of third light emitting devices. The flexible printed circuit board comprises a first electrical conducting path, a second electrical conducting path, a third electrical conducting path, a fourth electrical conducting path, a fifth electrical conducting path, a sixth electrical conducting path, and a seventh electrical conducting path. The first electrical conducting path and the third electrical conducting path and the fifth electrical conducting path and the seventh electrical conducting path each have two opposite ends and a bonding metal contact at each of the two opposite ends on top and bottom sides of the flexible printed circuit board. The second electrical conducting path have two opposite ends respectively coupled to the first electrical conducting path and the third electrical conducting path. The fourth electrical conducting path have two opposite ends respectively coupled to the first electrical conducting path and the fifth electrical conducting path. The sixth electrical conducting path has two opposite ends respectively coupled to the first electrical conducting path and the seventh electrical conducting path. The first light emitting devices are installed in the second electrical conducting path, each having a positive pole coupled to the first electrical conducting path and a negative pole coupled to the third electrical conducting path. The second light emitting devices are installed in the fourth electrical conducting path, each having a positive pole coupled to the first electrical conducting path and a negative pole coupled to the fifth electrical conducting path. The third light emitting devices are installed in the sixth electrical conducting path, each having a positive pole coupled to the first electrical conducting path and a negative pole coupled to the seventh electrical conducting path. When a DC power source is electrically connected to the bonding metal contacts of the first electrical conducting path and the bonding metal contacts of the third electrical conducting path and fifth electrical conducting path and seventh electrical conducting path, the first light emitting devices and the second light emitting devices and the third light emitting devices are turned on to emit light.

### BRIEF DESCRIPTION OF THE DRAWINGS

FIG. 1 is an oblique elevation of a flexible light bar according to the prior art.

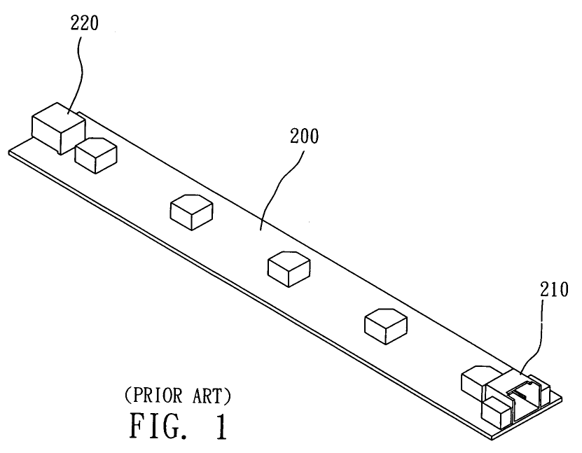

FIG. 2 is an oblique elevation of a flexible light bar according to the present invention.

FIG. 3 is a schematic drawing showing the circuit diagram of the flexible light bar according to the present invention.

FIG. 4 is a schematic drawing showing two flexible light bars connected in series according to the present invention.

FIG. 5 is a schematic drawing showing an alternate form of the circuit diagram of the flexible light bar according to the present invention.

FIG. 6 is a schematic drawing showing the fabrication flow of the flexible light bar according to the present invention.

### DETAILED DESCRIPTION OF THE PREFERRED EMBODIMENT

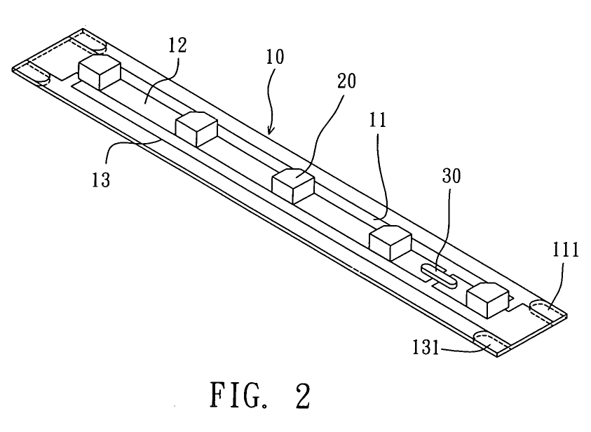

Referring to FIG. 2˜3, a flexible light bar in accordance with the present invention is shown comprised of a flexible PC (printed circuit) board 10, and a plurality of light emitting devices 20.

The flexible PC board 10 according to this embodiment is a soft circuit board, having a first electrical conducting path 11, a second electrical conducting path 12, and a third electrical conducting path 13. The second electrical conducting path 12 is disposed between the first electrical conducting path 11 and the third electrical conducting path 13. The first electrical conducting path 11 and the second electrical conducting path 12 each have at least one metal bonding contact 111 or 131 at each of the respective two opposite ends on both the top and bottom sides of the flexible PC board 10. The second electrical conducting path 12 has its two opposite ends respectively coupled to the first electrical conducting path 11 and the third electrical conducting path 13. The metal bonding contacts 111 and 131 are to be bonded to the metal bonding contacts of another light bar by soldering or by means of a double-sided adhesive metal conducting tape, minimizing the thickness.

The light emitting devices 20 according to this embodiment are monochromic LED (light emitting diode) installed in the second electrical conducting path 12. The number of the light emitting devices 20 can be changed as desired. According to this embodiment, the number of the light emitting devices 20 is five. The light emitting devices 20 each have a positive pole (due to it is a prior art in the LED field, so not shown in the figs) respectively coupled to the first electrical conducting path 11 and a negative pole (due to it is a prior art in the LED field, so not shown in the figs) respectively coupled to the third electrical conducting path 13.

Further, at least one current-limit resistor 30 is installed in the second electrical conducting path 12 and electrically connected in series to the light emitting devices 20. The number of the current-limit resistor 30 may be changed as desired. According to this embodiment, the number of the current-limit resistor 30 is two.

The light bar further comprises an antistatic device 40 coupled between one metal bonding contact 111 of the first electrical conducting path 11 and the corresponding metal bonding contact 131 of the third electrical conducting path 13 to protect the light emitting devices 20 against static electricity. The antistatic device 40 may be prepared in any of a variety of forms. According to this embodiment, the antistatic device 40 is a zener diode.

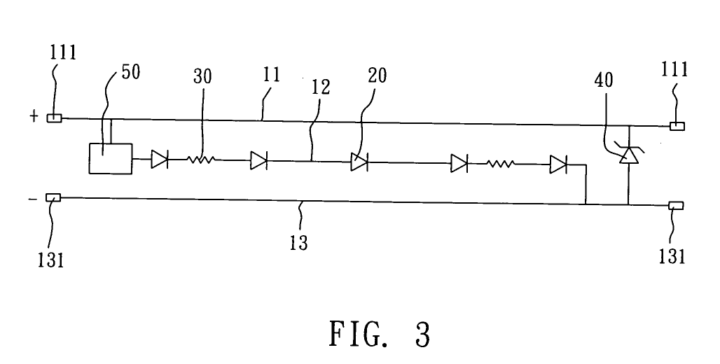

The light bar further comprises a controller 50 (shown in FIG. 3) electrically connected in series between the first electrical conducting path 11 and the light emitting devices 20 for controlling the lighting sequence and time of the light emitting devices 20 and the electric current passing through the light emitting devices 20.

When assembled, a DC power source, for example, +5V battery is connected between one metal bonding contact 111 of the first electrical conducting path 11 and the corresponding metal bonding contact 131 of the third electrical conducting path 13 to provide the necessary working voltage to the light emitting devices 20 so that the controller 50 can control the lighting pattern and time of the light emitting devices 20.

FIG. 3 is a circuit diagram of the flexible light bar. As illustrated, the flexible PC board 10 of the flexible light bar has a first electrical conducting path 11, a second electrical conducting path 12, and a third electrical conducting path 13. The first electrical conducting path 11 is coupled to the positive pole of the DC power source. The third electrical conducting path 13 is coupled to the negative pole of the DC power source. The second electrical conducting path 12 has installed therein a plurality of light emitting devices 20 and current-limit resistors 30. Further, an antistatic device 40, for example, a zener diode is coupled between the first electrical conducting path 11 and the third electrical conducting path 13. The number of the light emitting devices 20 and the number of the current-limit resistors 30 may be changed as desired. According to this embodiment, the number of the light emitting devices 20 is five, and the number of the current-limit resistors 30 is two.

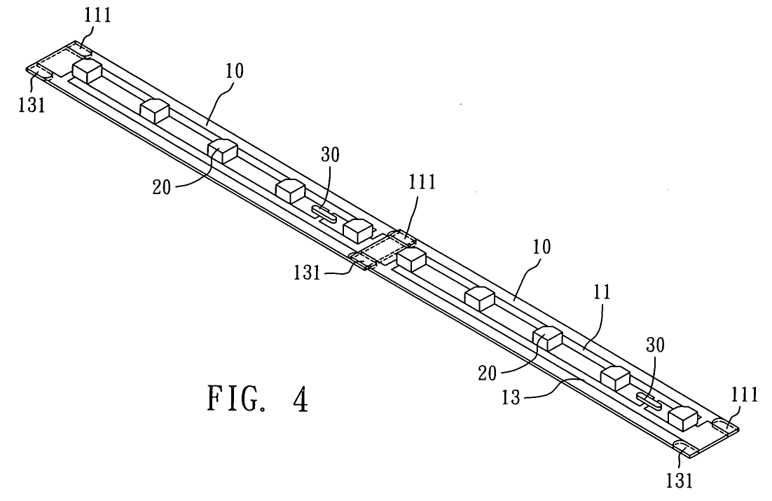

Referring to FIG. 4, by means of soldering, a plurality of flexible light bars can be connected in series to extend the length. By means of bonding the metal bonding contacts 111 and 131 of the first and third electrical conducting paths 11 and 13 on the top side at one end of one flexible light bar to the metal bonding contacts 111 and 131 of the first and third electrical conducting paths 11 and 13 on the bottom side at one end of another flexible light bar, a plurality of flexible light bars are connected in series. The bonding can be done by soldering or by means of a double-sided adhesive metal conducting tape. When compared with the prior art design, the invention greatly reduces the thickness and saves much the connector cost.

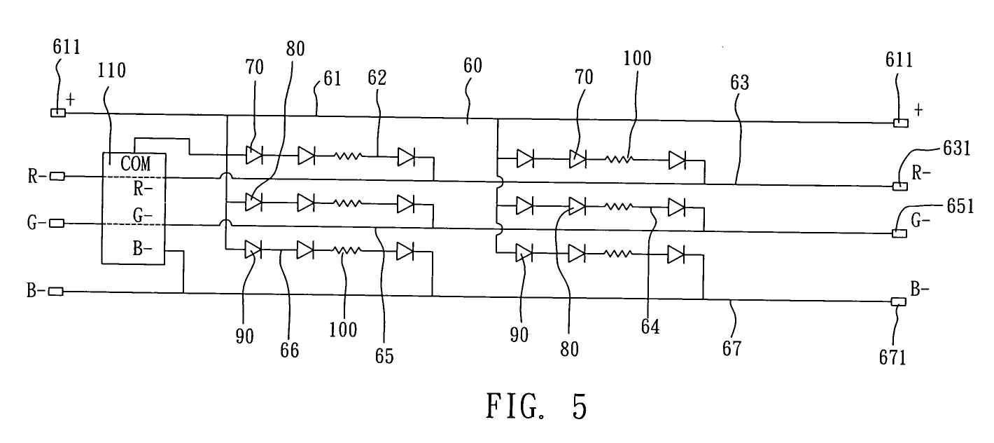

FIG. 5 shows an alternate form of the flexible light bar. According to this embodiment, the flexible light bar is comprised of a flexible PC board 60, a plurality of first light emitting devices 70, a plurality of second light emitting devices 80, and a plurality of third light emitting devices 90.

The flexible PC board 60 is a soft PC board having a first electrical conducting path 61, a second electrical conducting path 62, a third electrical conducting path 63, a fourth electrical conducting path 64, a fifth electrical conducting path 65, a sixth electrical conducting path 66, and a seventh electrical conducting path 67. The first electrical conducting path 61, the third electrical conducting path 63, the fifth electrical conducting path 65 and the seventh electrical conducting path 67 each have at least one metal bonding contact 611, 631, 651, or 671 on the top and bottom sides of each of the two opposite ends of the flexible PC board 60. The two opposite ends of the second electrical conducting path 62 are respectively coupled to the first electrical conducting path 61 and the third electrical conducting path 63. The two opposite ends of the fourth electrical conducting path 64 are respectively coupled to the first electrical conducting path 61 and the fifth electrical conducting path 65. The two opposite ends of the sixth electrical conducting path 66 are respectively coupled to the first electrical conducting path 61 and the seventh electrical conducting path 67. By means of bonding one metal bonding contact 611, 631, 651, and 671 on the top side of one end of the flexible PC board 60 of one flexible light bar to one metal bonding contact 611, 631, 651, and 671 on the bottom side of one end of the flexible PC board 60 of another flexible light bar, a plurality of flexible light bars are connected in series to extend the length.

According to this embodiment, the first light emitting devices 70 are red LEDs (light emitting diodes) installed in the second electrical conducting path 62, having the respective positive poles (+) (due to it is a prior art in the LED field, so not shown in the fig) respectively coupled to the first electrical conducting path 61 and the respective negative poles (−) (due to it is a prior art in the LED field, so not shown in the fig) respectively coupled to the third electrical conducting path 63. According to this embodiment, the number of the first light emitting devices 70 is six. However, the number of the first light emitting devices 70 may be changed as desired.

The second light emitting devices 80 according to this embodiment are green LEDs (light emitting diodes), having the respective positive poles (+) (due to it is a prior art in the LED field, so not shown in the fig) respectively coupled to the first electrical conducting path 61 and the respective negative poles (−) (due to it is a prior art in the LED field, so not shown in the fig) respectively coupled to the fifth electrical conducting path 65. According to this embodiment, the number of the second light emitting devices 80 is six. However, the number of the second light emitting devices 80 may be changed as desired.

The third light emitting devices 90 according to this embodiment are blue LEDs (light emitting diodes), having the respective positive poles (+) (due to it is a prior art in the LED field, so not shown in the fig) respectively coupled to the first electrical conducting path 61 and the respective negative poles (−) (due to it is a prior art in the LED field, so not shown in the fig) respectively coupled to the seventh electrical conducting path 67. According to this embodiment, the number of the third light emitting devices 90 is six However, the number of the third light emitting devices 90 may be changed as desired.

According to this embodiment, the first light emitting devices 70, the second light emitting devices 80, and the third light emitting devices 90 are monochromic LEDs embedded in a shell.

Further, the second electrical conducting path 62, the fourth electrical conducting path 64, and the sixth electrical conducting path 66 each have at least one current-limit resistor 100 installed therein and respectively connected in series to the associating light emitting devices 70, 80, or 90. According to this embodiment, two current-limit resistors 100 are installed in each of the second electrical conducting path 62, the fourth electrical conducting path 64, and the sixth electrical conducting path 66. However, the number of the current-limit resistors 100 may be changed as desired.

Further, two antistatic devices (due to they are prior arts in the technical field, so not shown in the fig) are installed in the flexible PC board 60 and respectively coupled between the first electrical conducting path 61 and the third electrical conducting path 63, and between the fifth electrical conducting path 65 and the seventh electrical conducting path 67 to protect the first light emitting devices 70, the second light emitting devices 80, and/or the third light emitting devices 90 against static electricity. The antistatic devices may be prepared in any of a variety of forms. According to this embodiment, the antistatic devices are zener diodes.

The light bar further comprises a controller 110 electrically coupled between the first electrical conducting path 61 and the first light emitting devices 70, second light emitting devices 80 and third light emitting devices 90 for controlling the lighting sequence and time of the first light emitting devices 70, second light emitting devices 80 and third light emitting devices 90 and the electric current passing through the first light emitting devices 70, second light emitting devices 80 and third light emitting devices 90.

When assembled, a DC power source, for example, +5V battery is electrically coupled between the metal bonding contact 611, 631, 651, and 671 so that the controller 110 can control the lighting pattern and time of the first light emitting devices 70, second light emitting devices 80 and third light emitting devices 90. Similar to the connection shown in FIG. 4, a plurality of flexible light bars of this embodiment can also be connected in series to extend the length by means of bonding the metal bonding contacts 611, 631, 641, and 671 on one side of one end the PC board 60 of one flexible light bar to the metal bonding contacts 611, 631, 641, and 671 on the other side of one end of the PC board 60 of another flexible light bar.

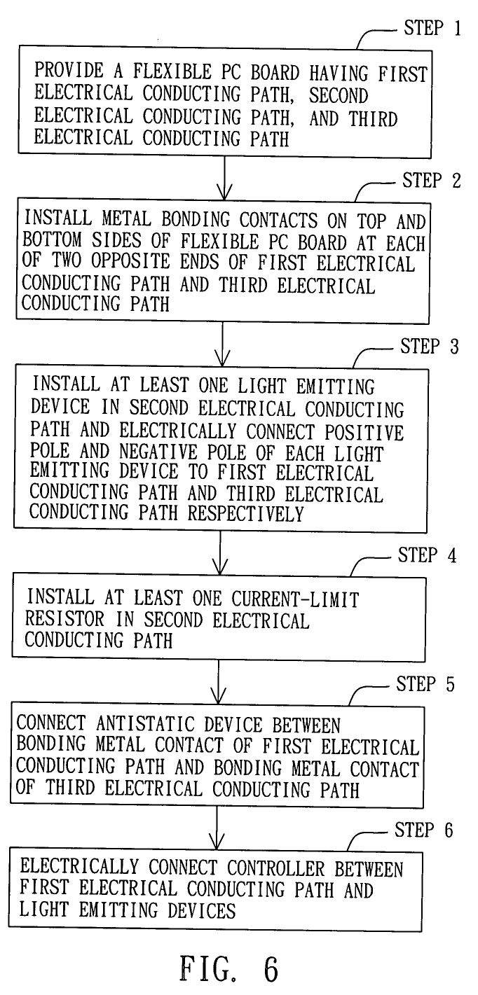

Referring to FIG. 6, a flexible light bar fabrication method in accordance with the present invention comprises the steps of:

(1) Provide a flexible PC board 10 having a first electrical conducting path 11, a second electrical conducting path 12, and a third electrical conducting path 13;

(2) Install metal bonding contacts 111 and 131 on the top and bottom sides of the flexible PC board 10 at each of the two opposite ends of the first electrical conducting path 11 and the third electrical conducting path 13; and

(3) Install at least one light emitting device 20 in the second electrical conducting path 12 and electrically connect the positive pole and negative pole of each light emitting device 20 to the first electrical conducting path 11 and the third electrical conducting path 13 respectively.

With respect to the related description regarding steps (1)˜(3), please refer to the description of the aforesaid FIGS. 2˜4.

The flexible light bar fabrication method further comprises step: (4) Install at least one current-limit resistor 30 in the second electrical conducting path 12 and electrically connect the at least one current-limit resistor 20 in series to the light emitting devices 20. Further, the number of the current-limit resistor 30 is determined subject to actual requirements.

The flexible light bar fabrication method further comprises step: (5) Install an antistatic device 40 in the flexible PC board 10 and electrically connect the antistatic device 40 between the bonding metal contact 111 at one end of the first electrical conducting path 11 and the bonding metal contact 131 at the corresponding one end of the third electrical conducting path 13 to protect the light emitting devices 20 against static electricity. Further, the antistatic device 40 can be a zener diode.

The flexible light bar fabrication method further comprises step: (6) Electrically connect a controller 50 between the first electrical conducting path 11 and the light emitting devices 20 to control the lighting sequence and time of the light emitting devices 20.

The flexible light bar and its fabrication of the present invention have the advantages of low device profile and low manufacturing cost, i.e., the invention eliminates the drawbacks of the prior art design.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A flexible light bar comprising:
a flexible printed circuit board, said flexible printed circuit board comprising a first electrical conducting path, a second electrical conducting path, and a third electrical conducting path, said second electrical conducting path having two opposite ends respectively coupled to said first electrical conducting path and said third electrical conducting path, said first electrical conducting path and said third electrical conducting path each having two opposite ends and a bonding metal contact at each of the two opposite ends on top and bottom sides of said flexible printed circuit board; and
a plurality of light emitting devices installed in said second electrical conducting path, said light emitting devices each having a positive pole coupled to said first electrical conducting path and a negative pole coupled to said third electrical conducting path; and
wherein said light emitting devices are turned on to emit light upon connection of a DC power source to the bonding metal contacts of said first electrical conducting path and said third electrical conducting path.

2. The flexible light bar as claimed in claim 1, further comprising at least one current-limit resistor installed in said second electrical conducting path and electrically connected in series to said light emitting devices.

3. The flexible light bar as claimed in claim 1, further comprising an antistatic device formed of a zener diode and electrically connected between said first electrical conducting path and said third electrical conducting path to protect said light emitting devices against static electricity.

4. The flexible light bar as claimed in claim 1, wherein said light emitting devices are monochromic light emitting diodes.

5. The flexible light bar as claimed in claim 1, further comprising a controller connected in series between said first electrical conducting path and said light emitting devices for controlling on/off, lighting sequence, lighting current, and lighting time of said light emitting devices.

6. The flexible light bar as claimed in claim 1, wherein said bonding metal contacts are electrically connectable to an external device by means of one of soldering connection method and double-sided adhesive metal conducting tape connection method.

7. A flexible light bar comprising:
a flexible printed circuit board, said flexible printed circuit board comprising a first electrical conducting path, a second electrical conducting path, a third electrical conducting path, a fourth electrical conducting path, a fifth electrical conducting path, a sixth electrical conducting path, and a seventh electrical conducting path, said first electrical conducting path and said third electrical conducting path and said fifth electrical conducting path and said seventh electrical conducting path each having two opposite ends and a bonding metal contact at each of the two opposite ends on top and bottom sides of said flexible printed circuit board, said second electrical conducting path having two opposite ends respectively coupled to said first electrical conducting path and said third electrical conducting path, said fourth electrical conducting path having two opposite ends respectively coupled to said first electrical conducting path and said fifth electrical conducting path, said sixth electrical conducting path having two opposite ends respectively coupled to said first electrical conducting path and said seventh electrical conducting path;
a plurality of first light emitting devices installed in said second electrical conducting path, said first light emitting devices each having a positive pole respectively coupled to said first electrical conducting path and a negative pole respectively coupled to said third electrical conducting path;
a plurality of second light emitting devices installed in said fourth electrical conducting path, said second light emitting devices each having a positive pole respectively coupled to said first electrical conducting path and a negative pole respectively coupled to said fifth electrical conducting path; and
a plurality of third light emitting devices installed in said sixth electrical conducting path, said third light emitting devices each having a positive pole respectively coupled to said first electrical conducting path and a negative pole respectively coupled to said seventh electrical conducting path;
wherein when a DC power source is electrically connected to the bonding metal contacts of said first electrical conducting path and the bonding metal contacts of said third electrical conducting path and said fifth electrical conducting path and said seventh electrical conducting path, said first light emitting devices and said second light emitting devices and said third light emitting devices are turned on to emit light.

8. The flexible light bar as claimed in claim 7, further comprising a plurality of current-limit resistors respectively installed in said second electrical conducting path and said fourth electrical conducting path and said sixth electrical conducting path and respectively connected in series to said first light emitting devices and said second light emitting devices and said third light emitting devices.

9. The flexible light bar as claimed in claim 7, further comprising a plurality of antistatic devices respectively formed of a zener diode and respectively coupled between said first electrical conducting path and said third electrical conducting path and between said fifth electrical conducting path and said seventh electrical conducting path to protect said first light emitting devices, said second light emitting devices, and said third light emitting devices against static electricity.

10. The flexible light bar as claimed in claim 7, wherein said first light emitting devices and said second light emitting devices and said third light emitting devices are monochromic light emitting diodes respectively packaged in a shell.

11. The flexible light bar as claimed in claim 7, further comprising a controller coupled between said first electrical conducting path and said first light emitting devices, said second light emitting devices and said third light emitting devices and adapted to control lighting sequence, lighting current and lighting times of said first light emitting devices, said second light emitting devices and said third light emitting devices.

12. The flexible light bar as claimed in claim 11, wherein said first light emitting devices are red light emitting diodes, said second light emitting devices are green light emitting diodes, and said third light emitting devices are blue light emitting diodes.

13. The flexible light bar as claimed in claim 7, wherein said bonding metal contacts are electrically connectable to an external device by means of one of soldering connection method and double-sided adhesive metal conducting tape connection method.

14. A flexible light bar fabrication method comprising the steps of:
1) providing a flexible printed circuit board having a first electrical conducting path, a second electrical conducting path, and a third electrical conducting path;
2) installing a bonding metal contact on each of top and bottom sides of said flexible printed circuit board at each of two opposite ends of each of said first electrical conducting path and said second electrical conducting path; and
3) installing a plurality of light emitting devices in said second electrical conducting path and electrically coupling positive pole and negative pole of each of said light emitting devices to said first electrical conducting path and said third electrical conducting path respectively.

15. The flexible light bar fabrication method as claimed in claim 14, further comprising step 4) installing at least one current-limit resistor in said second electrical conducting path and electrically connecting said at least one current-limit resistor in series to said light emitting devices.

16. The flexible light bar fabrication method as claimed in claim 14, further comprising the step 5) electrically connecting an antistatic device between the bonding metal contact at one end of said first electrical conducting path and the bonding metal contact at the corresponding end of said third electrical conducting path.

17. The flexible light bar fabrication method as claimed in claim 14, wherein said antistatic device is a zener diode.

18. The flexible light bar fabrication method as claimed in claim 14, wherein said light emitting devices are monochromic light emitting diodes.

19. The flexible light bar fabrication method as claimed in claim 14, further comprising the step 6) electrically coupling a controller between said first electrical conducting path and said light emitting devices for controlling the lighting sequence, lighting current and lighting time of said light emitting devices.

20. The flexible light bar fabrication method as claimed in claim 14, wherein said bonding metal contacts are electrically connectable to an external device by means of one of soldering connection method and double-sided adhesive metal conducting tape connection method.
